(19) United States
(12) Patent Application Publication
(10) Pub. No.: US 2020/0005204 A1
(43) Pub. Date: Jan. 2, 2020

(54) DETERMINING EMPLOYMENT TYPE BASED ON MULTIPLE FEATURES

(71) Applicant: Microsoft Technology Licensing, LLC, Redmond, WA (US)

(72) Inventors: Hitesh Kumar, San Francisco, CA (US); Michael Jennings, San Francisco, CA (US); Xin Xia, Pacifica, CA (US); David Golland, Oakland, CA (US); Daniel Francis, Belmont, CA (US); Ted Tomlinson, Oakland, CA (US)

(21) Appl. No.: 16/023,895

(22) Filed: Jun. 29, 2018

(51) Int. Cl. G06Q 10/06; G06F 15/18; G06F 17/30; G06Q 50/00

(52) U.S. Cl. CPC G06Q 10/0631; G06Q 10/067; G06Q 50/01; G06F 17/30867; G06F 15/18

(57) ABSTRACT

Methods, systems, and computer programs are presented for determining the employment type of online-service members and the generation of employment reports. One method includes training a machine learning program (MLP) for categorizing employment type, for title and company, as field or full-time-corporate. The full-time-corporate category is for full-time corporate employees. For each employee title in a first company, the method includes accessing data for members of an online service having the title and employed by the first company, and determining, by the trained MLP, the employment type for the title and the first company based on the accessed data. Further, the method includes operations for providing a user interface for generating an employment report for the first company, the user interface including one or more options for filtering data based on the employment type, and for presenting the employment report on the user interface.

### TECHNICAL FIELD

The subject matter disclosed herein generally relates to methods, systems, and programs for determining employment types for members of an online service.

### BACKGROUND

Employment market data is very important for fast growing companies because these companies want to understand employment-related data, such as what the population is for a given skill set, where potential employees are located, what the typical compensation is, whether people for a certain skill are changing jobs often, etc. Further, a good understanding of the labor market may assist a company deciding where to establish a new site because the company may choose a site with a readily-available workforce.

However, employment data is usually kept secret by most companies, which merely provide, sometimes, the number of employees of the company. Therefore, getting a thorough understanding of the labor market based on available skills and geography is a difficult task.

A key piece of employment information is understanding the composition of the labor force and the types of employment for company workers. Company managers are often interested in generating employment reports that differentiate between full-time corporate employees versus other types of employees, such as field employees, but this type of distinction is not available based on the employee data available through an online service.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments, including a social networking server.

FIG. 2 is a screenshot of a user's profile, according to some example embodiments.

FIG. 3 is a user interface for a talent pool report, according to some example embodiments.

FIG. 4 is a flowchart of a method for generating reports based on employment type, according to some example embodiments.

FIG. 5 illustrates the process for determining model parameters, according to some example embodiments.

FIG. 6 illustrates data structures for storing job and member information, according to some example embodiments.

FIG. 7 illustrates the feature-extraction process, according to some example embodiments.

FIG. 8 illustrates the training and use of a machine-learning program, according to some example embodiments.

FIG. 9 is a table for an employment status taxonomy, according to some example embodiments.

FIG. 10 is a workforce-distribution report for a company, according to some example embodiments.

FIG. 11 is a report for talent flow between companies, according to some example embodiments.

FIG. 12 illustrates a social networking server for implementing example embodiments.

FIG. 13 is a flowchart of a method for determining employment type, according to some example embodiments.

FIG. 14 is a block diagram illustrating an example of a machine upon or by which one or more example process embodiments described herein may be implemented or controlled.

### DETAILED DESCRIPTION

Example methods, systems, and computer programs are directed to determining the type of employment for members of an online service and the generation of employment reports based on the type of employment. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Many companies have employees who do not work in corporate offices and are not permanent full-time employees. Sometimes, these employees constitute a large fraction of the company's workforce. Some examples include retail warehouse workers, coffee shop baristas, peer-to-peer ridesharing drivers, interns, contractors, etc. These employees are referred to herein as field employees, and employees who are not field employees are referred to as full-time-corporate employees. Implementations presented herein describe how to determine the type of employment (e.g., field vs. full-time-corporate) based on information available for the members of the online service. In some example embodiments, the online service is a social network.

Once the employment type is determined, this information may be used as a filter to generate employment reports that describe the distribution of these types of employees, such as geographic distribution, percentage of the workforce, etc., as well as to compare one company with other companies, e.g., how the distribution by employment type varies from company to company.

Determining if employees are full-time-corporate or not is a difficult task because this information is not typically entered by the members. Given the large variation in employment types and titles submitted by the members, it is not straightforward to perform this categorization. The embodiments presented herein show a technical solution for the technical problem of differentiating between full-time-corporate and field employees by analyzing data of multiple types in order to determine which employment type corresponds to which title within a company.

In one embodiment, a method is provided. The method includes training a machine learning program for categorizing an employment type, for a title and a company, as field or full-time-corporate, full-time-corporate category being for full-time corporate employees. For each title of employees in a first company, perform operations accessing data for members of an online service having the title and employed by the first company, and determining, by the trained machine learning program, the employment type for the title and the first company based on the accessed data. Further, the method includes an operation for providing a user interface for generating an employment report for the first company, the user interface including one or more options for filtering data based on the employment type. The method further includes an operation for causing presentation of the employment report, requested by a user, on the user interface.

In another embodiment, a system includes a memory comprising instructions and one or more computer processors. The instructions, when executed by the one or more computer processors, cause the one or more computer processors to perform operations comprising: training a machine learning program for categorizing an employment type, for a title and a company, as field or full-time-corporate, full-time-corporate category being for full-time corporate employees; for each title of employees in a first company accessing data for members of an online service having the title and employed by the first company, and determining, by the trained machine learning program, the employment type for the title and the first company based on the accessed data; providing a user interface for generating an employment report for the first company, the user interface including one or more options for filtering data based on the employment type; and causing presentation of the employment report, requested by a user, on the user interface.

In yet another embodiment, a machine-readable storage medium (e.g., a non-transitory storage medium) includes instructions that, when executed by a machine, cause the machine to perform operations comprising: training a machine learning program for categorizing an employment type, for a title and a company, as field or full-time-corporate, full-time-corporate category being for full-time corporate employees; for each title of employees in a first company accessing data for members of an online service having the title and employed by the first company, and determining, by the trained machine learning program, the employment type for the title and the first company based on the accessed data; providing a user interface for generating an employment report for the first company, the user interface including one or more options for filtering data based on the employment type; and causing presentation of the employment report, requested by a user, on the user interface.

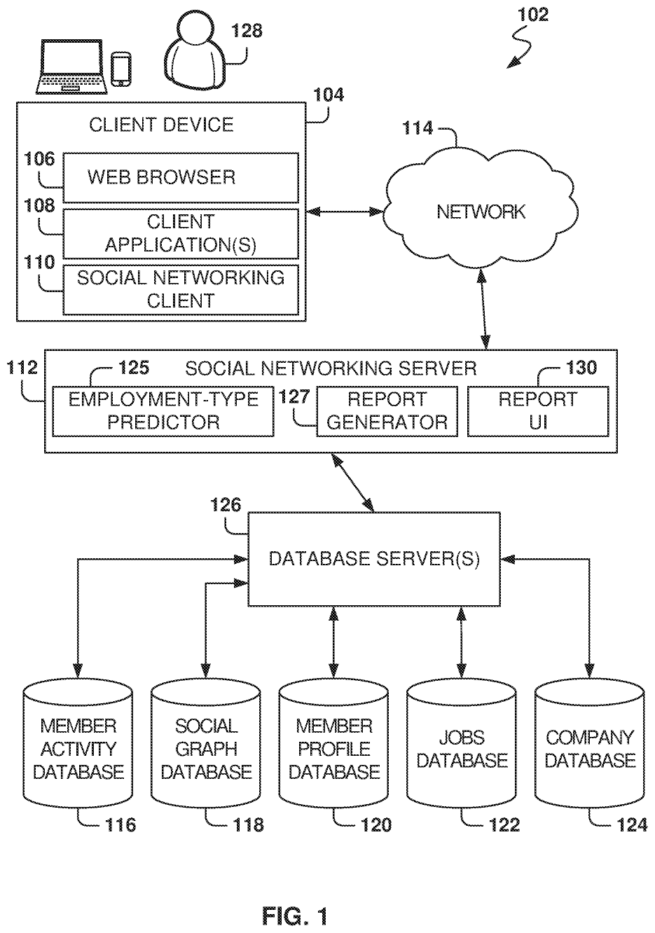

FIG. 1 is a block diagram illustrating a networked system, according to some example embodiments, including a social networking server 112, illustrating an example embodiment of a high-level client-server-based network architecture 102. The social networking server 112 provides server-side functionality for the online service via a network 114 (e.g., the Internet or a wide area network (WAN)) to one or more client devices 104. FIG. 1 illustrates, for example, a web browser 106, client application(s) 108, and a social networking client 110 executing on a client device 104. The social networking server 112 is further communicatively coupled with one or more database servers 126 that provide access to one or more databases 116-124.

The client device 104 may comprise, but is not limited to, a mobile phone, a desktop computer, a laptop, a portable digital assistant (PDA), a smart phone, a tablet, a netbook, a multi-processor system, a microprocessor-based or programmable consumer electronic system, or any other communication device that a user 128 may utilize to access the social networking server 112. In some embodiments, the client device 104 may comprise a display module (not shown) to display information (e.g., in the form of user interfaces).

In one embodiment, the social networking server 112 is a network-based appliance that responds to initialization requests or search queries from the client device 104. One or more users 128 may be a person, a machine, or other means of interacting with the client device 104. In various embodiments, the user 128 is not part of the network architecture 102, but may interact with the network architecture 102 via the client device 104 or another means.

The client device 104 may include one or more applications (also referred to as “apps”) such as, but not limited to, the web browser 106, the social networking client 110, and other client applications 108, such as a messaging application, an electronic mail (email) application, a news application, and the like. In some embodiments, if the social networking client 110 is present in the client device 104, then the social networking client 110 is configured to locally provide the user interface for the application and to communicate with the social networking server 112, on an as-needed basis, for data and/or processing capabilities not locally available (e.g., to access a member profile, to authenticate a user 128, to identify or locate other connected members, etc.). Conversely, if the social networking client 110 is not included in the client device 104, the client device 104 may use the web browser 106 to access the social networking server 112.

In addition to the client device 104, the social networking server 112 communicates with the one or more database server(s) 126 and database(s) 116-124. In one example embodiment, the social networking server 112 is communicatively coupled to a member activity database 116, a social graph database 118, a member profile database 120, a jobs database 122, and a company database 124. The databases 116-124 may be implemented as one or more types of databases including, but not limited to, a hierarchical database, a relational database, an object-oriented database, one or more flat files, or combinations thereof.

The member profile database 120 stores member profile information about members who have registered with the social networking server 112. With regard to the member profile database 120, the member may include an individual person or an organization, such as a company, a corporation, a nonprofit organization, an educational institution, or other such organizations. In some example embodiments, the member profile database 120 includes a member position database that holds the employment history of members.

Consistent with some example embodiments, when a user initially registers to become a member of the social networking service provided by the social networking server 112, the user is prompted to provide some personal information, such as name, age (e.g., birth date), gender, interests, contact information, home town, address, spouse's and/or family members' names, educational background (e.g., schools, majors, matriculation and/or graduation dates, etc.), employment history (e.g., companies worked at, periods of employment for the respective jobs, job title), professional industry (also referred to herein simply as “industry”), skills, professional organizations, and so on. This information is stored, for example, in the member profile database 120. Similarly, when a representative of an organization initially registers the organization with the social networking service provided by the social networking server 112, the representative may be prompted to provide certain information about the organization, such as a company industry. This information may be stored, for example, in the member profile database 120. In some embodiments, the profile data may be processed (e.g., in the background or offline) to generate various derived profile data. For example, if a member has provided information about various job titles that the member has held with the same company or different companies, and for how long, this information may be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

In some example embodiments, the company database 124 stores information regarding companies in the member's profile. A company may also be a member; however, some companies may not be members of the social network even though some of the employees of the company may be members of the social network. The company database 124 includes company information, such as name, industry, contact information, website, address, location, geographic scope, and the like.

As users interact with the social networking service provided by the social networking server 112, the social networking server 112 is configured to monitor these interactions. Examples of interactions include, but are not limited to, commenting on posts entered by other members, viewing member profiles, editing or viewing a member's own profile, sharing content outside of the social networking service (e.g., an article provided by an entity other than the social networking server 112), updating a current status, posting content for other members to view and comment on, posting job suggestions for the members, searching job posts, and other such interactions. In one embodiment, records of these interactions are stored in the member activity database 116, which associates interactions made by a member with his or her member profile stored in the member profile database 120. In one example embodiment, the member activity database 116 includes the posts created by the users of the social networking service for presentation on user feeds.

The jobs database 122 includes job postings offered by companies in the company database 124. Each job posting includes job-related information such as any combination of employer, job title, job description, requirements for the job, salary and benefits, geographic location, one or more job skills required, day the job was posted, relocation benefits, and the like.

In one embodiment, the social networking server 112 communicates with the various databases 116-124 through the one or more database server(s) 126. In this regard, the database server(s) 126 provide one or more interfaces and/or services for providing content to, modifying content in, removing content from, or otherwise interacting with the databases 116-124.

While the database server(s) 126 is illustrated as a single block one of ordinary skill in the art will recognize that the database server(s) 126 may include one or more such servers. For example, the database server(s) 126 may include, but are not limited to, a Microsoft® Exchange Server, a Microsoft® Sharepoint® Server, a Lightweight Directory Access Protocol (LDAP) server, a MySQL database server, or any other server configured to provide access to one or more of the databases 116-124, or combinations thereof. Accordingly, and in one embodiment, the database server(s) 126 implemented by the social networking service are further configured to communicate with the social networking server 112.

The social networking server 112 includes, among other modules, a employment-type predictor 125, a report generator 127, and a talent user interface 130. The modules may be implemented in hardware, software (e.g., programs), or a combination thereof. The employment-type predictor 125 estimates the type of employment of members, as described in more detail below. The report generator 127 generates the reports associated with the employment data, and the report user interface 130 provides an interface for accessing the reports and options for the report generation.

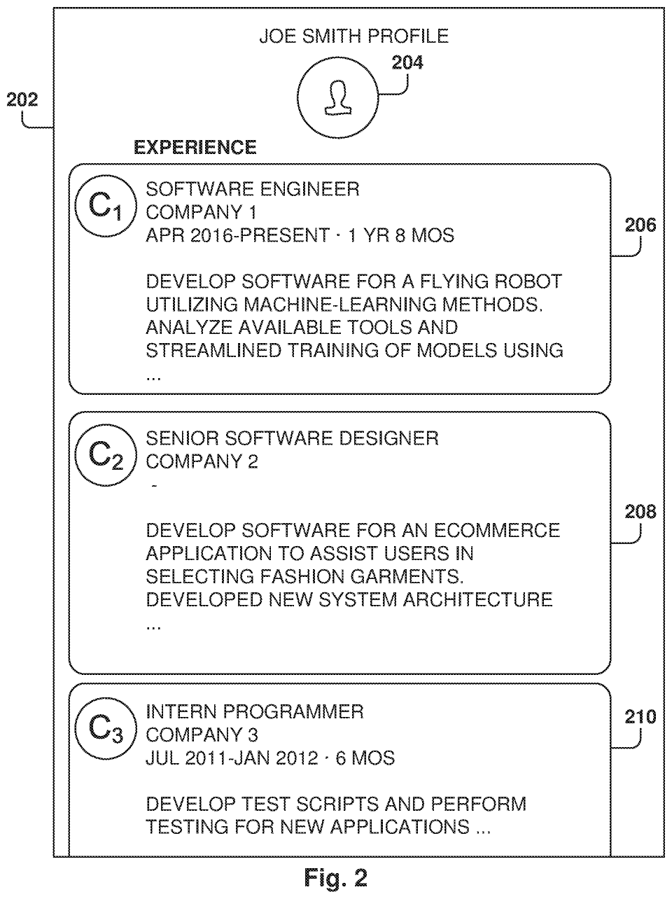

FIG. 2 is a screenshot 202 of a user's profile, according to some example embodiments. In the example embodiment of FIG. 2, the user's profile includes several jobs held by the user 204, in a format similar to the one used for a resume.

In one example embodiment, each job (206, 208, 210) includes a company logo for the employer (e.g., C₁), a title (e.g., software engineer), the name of the employer (e.g., Company 1), dates of employment, and a description of the job tasks or job responsibilities of the user 204. However, for job 208, employment dates are unknown so they are not shown.

In some example embodiments, the information on the user profiles may be categorized. For example, the company may include a company ID, a title may be assigned a title ID (where the title is standardized to cover a plurality of similar job titles), and a position may be assigned a position ID. In some example embodiments, each job (member_position) of the user may be described utilizing a record with one or more of the following fields: {member_id: int, position_id: int. company_id: int. is_current: boolean (indicating if this is believed to be the user's current job), industry_id: int. position_start_time: long, position_end_time: long}. Other embodiments may include additional fields or fewer fields.

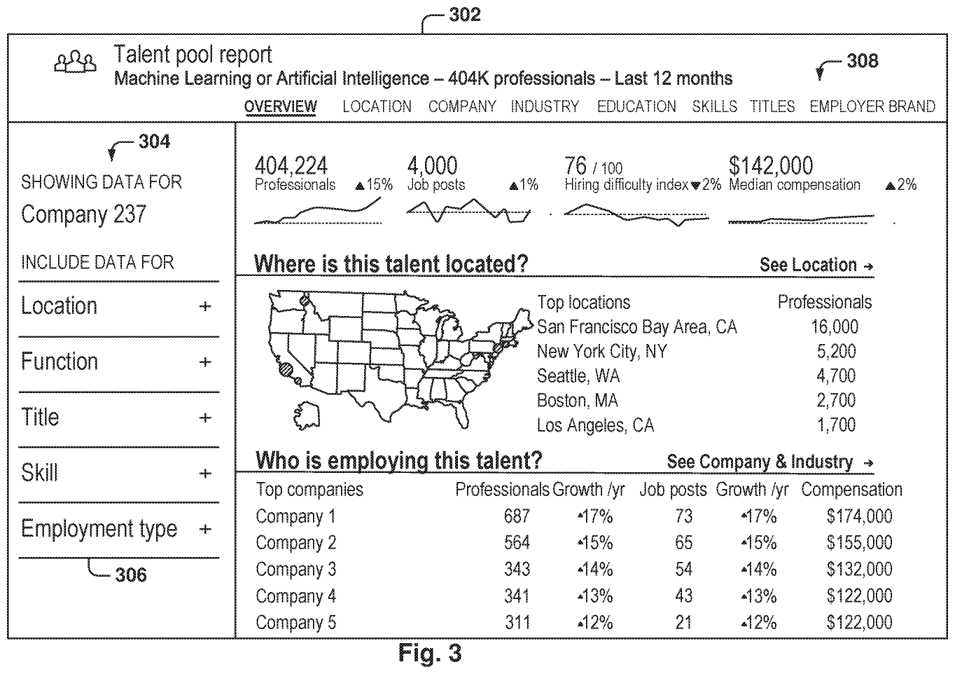

FIG. 3 is a user interface 302 for a talent pool report, according to some example embodiments. The talent pool report is a type of report that enables finding any population of talent, based on skills, titles, geographies, and industries, while providing insights to help create a talent-acquisition strategy. For example, if the company wants to hire 200 engineers with machine-learning skills, the company may conduct a search to identify where the talent with machine-learning skills is located. This helps the company decide in which locations to hire and establish working teams, or at which locations it will be more expensive to hire employees.

The user interface 302 includes a parameter-selection area 304 for setting filters associated with the talent report. In some example embodiments, the filters include location, function (e.g., marketing), title, skill, and employment type 306. The employment type option includes an option for selecting field or not, as well as other options related to employment, such as permanent employee, contractor, etc. As used herein, the term employment type refers to selecting one of field or full-time-corporate for a member of the social network, unless otherwise noted for describing another category for employment type.

The full-time-corporate type is an employment category for employees working full time at corporate offices. Otherwise, if the employee is not full-time-corporate the employee is referred to as a “field” employee. It is noted that some corporate employees may also be included in the field category, such as interns, contractors, and other employees that work at corporate offices but are not full-time corporate employees.

As used herein, the corporate offices include the headquarters (HQ) of the company and other locations focused on administrative tasks and Research and Development tasks (RND). Therefore, corporate offices include HQ offices and RND centers: non-corporate offices include manufacturing sites, distribution centers, sales offices (not at HQ), points of sale (e.g., stores, coffee shops, restaurants), points of service (e.g., apartment rental, hotel), warehouses, etc.

It is noted that field employees may get paid hourly or in other forms, such as by the week, by the month, etc.

One of the goals is to differentiate between individuals working full time at corporate officers and development centers from other individuals that perform routine tasks, typically paid by the hour. For example, a company providing peer-to-peer drivers may have many drivers distributed throughout the country, as well as other employees working in the corporate offices, which tend to be more concentrated within a geographical area. If a manager wants a report on attrition rates, the attrition rate may vary considerably between drivers and software engineers working at corporate. This is why, putting both types of employees in the same category may generate results with great variability. However, by separating the drivers from the corporate employees, reporting may generate more meaningful results when considering the drivers alone and when considering corporate employees alone.

Some people rent their houses and they list themselves as hosts within a house-renting website. This may greatly increase the number of employees of the house-renting business. By separating the hosts from full-time employees, it is easier to get relevant statistical information about the business, without considering the variability of hosts, which may rent one day a year or every day of the year. In addition to drivers and hosts, other field workers include coffee-shop baristas, retail workers, warehouse employees, etc.

Additionally, statistical parameters for the corporate employees may then be matched against corporate employees in other companies and the results will be more meaningful than if the field employees (e.g., drivers) are incorporated in the benchmarking.

In some example embodiments, the employment status is calculated for each title within a company. Based on information about each of the members of the social network, the system predicts the employment status for the given title in the company. The system may use indicators, such as using the work “contractor” or “freelance” in the title, as well as information extracted from user data, company data, job data, etc.

It is noted that embodiments are presented for categorizing employment type based on title and company. However, the model may be applied to more than two variables and use other types of variables. For example, categorization may be performed for a combination of title, company, and location; therefore, each location of the company would have its own categorization model. Further, there could be models applied even at the individual level and perform categorization for each employee of a company. Thus, the embodiments presented do not describe every possible combination of variables. The embodiments presented should therefore not be interpreted to be exclusive or limiting, but rather illustrative.

The user interface 302 of FIG. 3 shows a talent pool report 308 as an example for a super-title of machine learning or artificial intelligence for the last 12 months. The talent report 308 indicates that there are 404,224 professionals that match this skill in the geography of interest, the United States in this case. In this illustration, the employment type filter 306 has been set to full-time-corporate because employees with the title of machine learning or artificial intelligence are usually not field employees.

The report 302 includes numbers and graphical representation of the evolution of the professionals, the number of job posts identified in this period for machine learning, a hiring difficulty index, and the median compensation (together with respective growth indicators over the previous year).

Additionally, a map of the United States is shown with circles of varying sizes in proportion to the number of employees at the location, for the identified super-title or super-titles. Additionally, a table shows the tabular representation for the locations and the number of professionals in these locations.

Further yet, the report 308 includes a list of companies (e.g., top five) that are hiring this type of employee and a table is provided indicating, by company, the number of professionals employed at the company, the percentage growth by year, the number of job posts, the growth by each year in the number of job posts, and the median compensation.

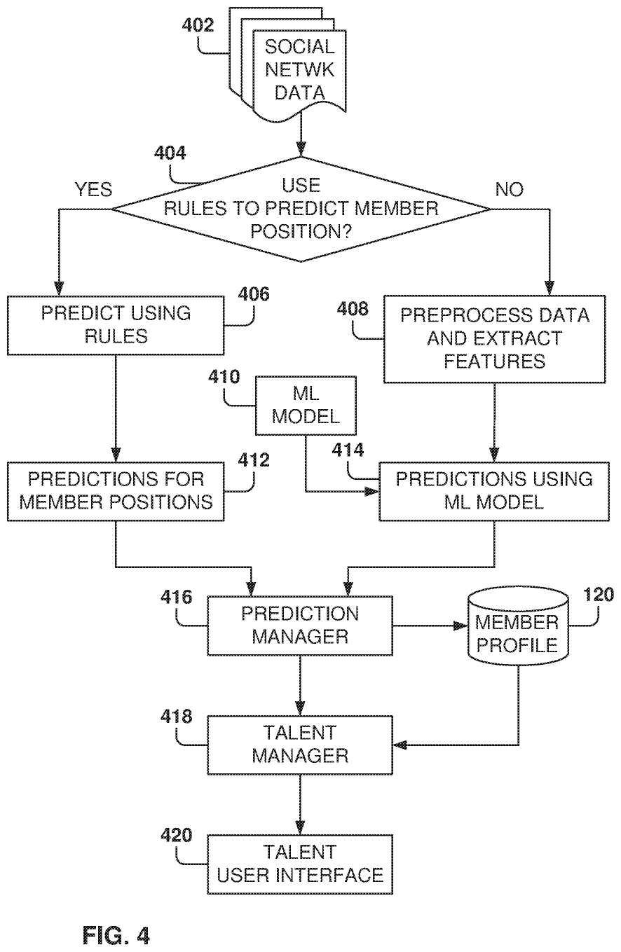

FIG. 4 is a flowchart of a method for generating reports based on employment type, according to some example embodiments. As mentioned above, each member position includes the raw title (as entered by the member in their profile) and the standardized company identifier. One goal is to identify the employment type for each title and company identifier.

Sometimes, there may be some titles that may have employees that are field and other employees that are full-time-corporate. For example, some companies may have recruiters operating as full-time salaried employees and other recruiters working as hourly contractors. In these cases, the combination of (title, company) will be assigned an employment type of full-time-corporate; that is, a title is assigned field status if all employees (or more than a certain percentage, such as 90% or 95%) in the company are field. In other example embodiments, when there are employees of both kinds for the same title, the combination of (title, company) is assigned the employment type of field. In other example embodiments, these employees may be assigned the employment type corresponding to the employment type having the highest number of employees.

The employment type predictor is a hybrid system that uses rules as well as a machine learning (ML) model. The predictions may be re-evaluated periodically based on additional available data. Further, the system may utilize rules to identify an initial category and then be switched to the ML model for ongoing categorization.

In some example embodiments, the member titles are evaluated based on social network data 402. A check is made at operation 404, and if there are one or more rules available to make a prediction using rules, the title will be evaluated using rules at operation 406; otherwise, the title will be evaluated utilizing the ML model at operation 408.

Thus, at operation 406, a prediction of the employment type is made based on rules identified by the social network manager. Some example of rules include: “software developers are full-time-corporate,” “baristas are field,” “house-rental host is field,” “vice-president in the title is full-time-corporate,” “intern in the title is field,” “contractor in the title is field,” etc. Additionally, some rules may combine multiple criteria. For example, a rule may combine word, or words, in the title with a specific company, e.g., “Recruiting coordinator at company A is field,” “Recruiting coordinator at company B is full-time-corporate.” The results are the predictions 412 for some member positions.

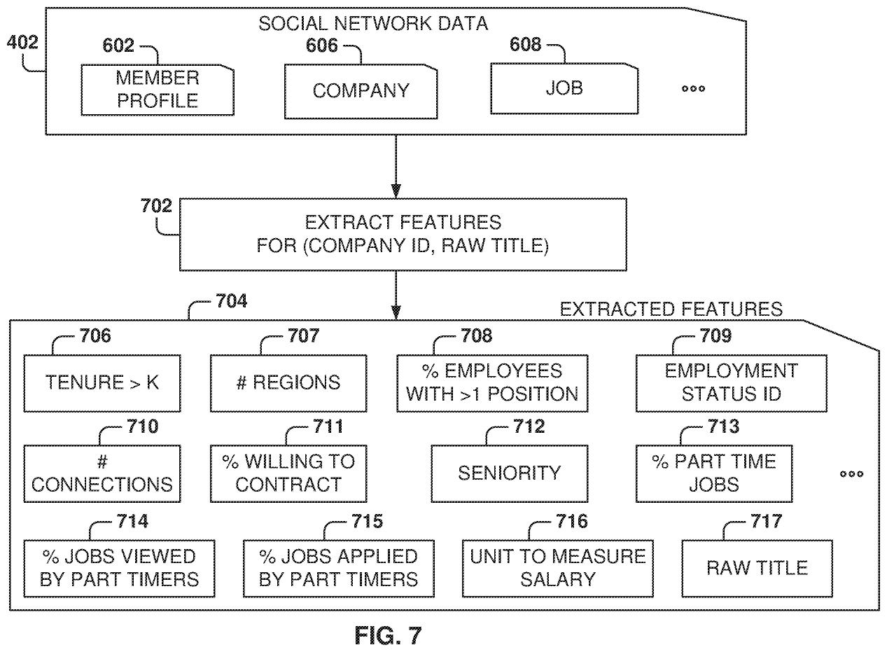

When using the ML model, at operation 408, the social network data is preprocessed and some features are extracted for the ML model 410. More details regarding extracted features are described below with reference to FIG. 7.

The ML model 410 is a binary classification problem resulting in 1 for field and 0 for full-time-corporate. The result of the classification problem is the predictions using the ML model 414. It is noted that in other embodiments, categorization may be applied to a representation with more than two values, such as variables defining, 3, 4 or any number of possible categories. This can be achieved via a “one-versus-one” method that applies a classifier for every pair of categories and chooses the class with the greatest number of predictions. It can also be achieved with a “one-versus-rest” strategy that creates a single classifier for each class against all other classes and chooses the class with the highest predicted score among all classifiers. It may also be appropriate to assign multiple class labels to a single member (multilabel) in the case that the classes are not exclusive. For example, an employee could be labeled as “field” and “full time” or “field” and “contractor”.

The prediction manager 416 stores the employment-type predictions in a member positions database, which is part of the member profile database 120, and this information is used by the talent manager 418 that generates the reports presented in the talent user interface 420.

There can be multiple member positions in a company with the same raw title. Thus, misclassifying titles that are common is worse than misclassifying titles that are less common. In some example embodiments, the results from the ML model 410 are categorized within the following four categories:

True Positive (TP)—member position where the true label is 1 and the model predicts 1;

True Negative (TN)—member position where the true label is 0 and the model predicts 0;

False Positive (FP)—member position where the true label is 0, and the model predicts 1: and

False Negative (FN)—member positions where the true label is 1, and the model predicts 0.

The ML model is evaluated measuring precision and recall as follows:

$$Precision = \frac{\# TP}{\# TP + \# FP}$$

$$Recall = \frac{\# TP}{\# TP + \# FN}$$

In some example embodiments, the goal is to achieve at least 90% precision and as much recall as possible. The member positions classified by the rule-based system are assumed to be correct (precision=100%) as domain experts create the rules for predicting the employment type. The goal is to build an ML model which has at least 90% precision so that the overall system precision is guaranteed to be at more than 90%.

Employees that work for a staffing company probably work at other companies under contract with a staffing company. In some example embodiments, employees working at staffing companies are assigned one of the employment types, such as full-time-corporate, because it is more difficult to classify a title when the company where the actual work is being done may be unknown. In other example embodiments, employees working at a staffing companies are assigned to field. In yet other example embodiments, the ML model is utilized in the prediction of employment type made for the employees working at staffing companies.

In some example embodiments, the schema for the results is as follows:

```
    {
    “type”: “record”,
    “name”: “SkilledAndHourlyInference”,
    “namespace”: “talentintel.avro”,
    “doc”: “For each member position, indicate
    if this position is inferred to
be SkilledAndHourly or not.”,
    “fields”:
    [
    {“name”: “memberId”; “type”: “long”,
    “doc”: “Id of the member
holding this position.”},
    {“name”: “positionId”, “type” : “int”,
    “doc”: “Id of this position.”},
    {“name”: “isSkilledAndHourly”, “type”:
    “boolean”, “doc”: “True if this
position is predicted to be SkilledAndHourly,
false otherwise.”},
    {“name”: “confidenceScore”, “type”:
    “double”, “doc”: “Confidence
score of this prediction between 0 and 1.
1 means highest confidence and 0
means lowest confidence.”}
    ] }
```

Thus, the schema includes information for the different member identifiers (IDs), position, Boolean value regarding employment type, and a confidence score of the result. The confident score for rule-base the terminations is 1, and the confidence score for ML-base determinations will be based on the score provided by the ML model.

In some example embodiments, the database schema for storing the employment type is as follows:

```
    {
    “name”: “MemberPositionInferredEmploymentType”,
    “namespace”: “com.talentintel.relevance.avro”,
    “type”: “record”,
    “doc”: “Represents the inferred employment
    type for member positions.
Currently, every member position is classified
as either field or full-time-
corporate, this system might be extended
to infer other employment types for
member positions later”,
    “fields”: [
    {“name”: “memberId”, “doc”: “Id of the
    member holding this
position.”, “type”: “long”},
    {name”: “positionId”, “doc”: “Id of the
position.”, “type”: “int” },
    “name”: “inferredEmploymentType”,
    “type”: {“type”: “enum”, “name”:
    “InferredEmploymentType”,
“symbols”: [“FULL_TIME_CORPORATE”,
“SKILLED_AND HOURLY”],
“symbolDocs”: [“FULLTIME_CORPORATE”:
“Represents full time
employees of a company who work in
their corporate offices like Software
Engineers, Product Managers etc.”,
“SKILLED_AND_HOURLY”: “Represents
employees who don't work in corporate
offices of companies, though constitute a
large part, of company's workforce like
uber drivers, airbnb host etc.”}},
      “doc”: “Inferred employment type of
      this member position.”},
    {“name”: “confidenceScore”, “doc”:
    “Confidence score in the inference
for this member position. Will be between 0
and 1 inclusive.”, “type”: “double”},
    {“name”: “inferenceSource”, “type”:
    {“type”: “enum”, “name”:
“InferenceSource”, “symbols”: [“ML_MODEL”,
“RULE” ], “symbolDocs”: {
“ML_MODEL”: “Prediction using the ML model.”,
“RULE”: “Prediction using rules
provided by domain experts.” } },
“doc”: “Source used to provide this
inference.”}
    ] }
```

As noted in the schema, in one embodiment, the schema is for categorizing field or full-time-corporate, but the schema may be extended to include other employment types.

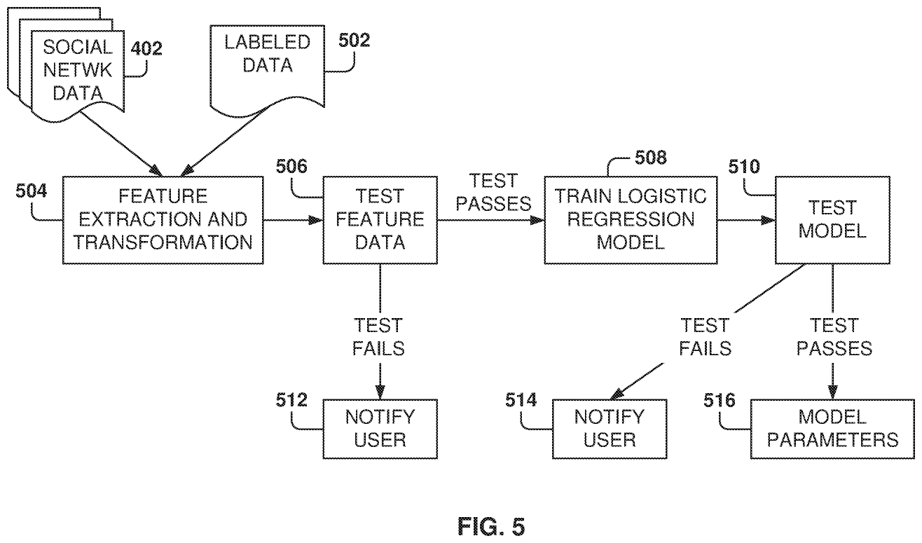

FIG. 5 illustrates the process for determining model parameters, according to some example embodiments. The ML model utilizes features that are based on the social network data 402. Additionally, at operation 504, additional features are extracted (e.g., calculated) based on the social network data 402.

Further, labeled data 502 is used for the training and testing of the ML model. The labeled data 502 includes values of the features used by the ML model and the value of the outcome (e.g., field or full-time-corporate). Initially, the labeled data may be labeled by human judges. Additionally, labeled data may be obtained over time based on feedback from companies, such as the companies using the talent reports, members, associated job-post records, and job-search signals.

Further yet, the labeled data 502 may be created programmatically generating some training data using prior knowledge to scale the size of the training data. Rules are used to label the data, such as employees with raw title “Software Engineers” and “Product Managers” are full-time-corporate employees, while employees with raw titles like “Barista.” “Bank teller,” and “Cashier” are field.

In some example embodiments, the labeled data 502 is divided into training data and test data. For example, 85% of the data may be used for training and 15% for validation, but other percentages may also be utilized.

Based on the features defined, the features extracted, and the labeled data, a test-feature data set 506 is created for training 508 a logistic regression model. The test feature data set 506 if for testing the values of features so that the features are as expected every time we train the model. Although embodiments are presented for a logistic regression model, other embodiments may utilize other ML models, such as Support Vector Machines (SVM), gradient boost, or decision trees.

In some example embodiments, the model hyperparameters on the training subset are tuned using k-fold stratified cross validation (grid search). This includes the logistic regression regularization parameter to be used, thresholding the minimum probability at which a positive prediction is considered positive. Since one goal is to maximize precision, false positives are to be avoided as much as possible.

The logistic regression model is trained. In some example embodiments, the logistic model is trained using the following hyperparameters on the full training set at step 1.
LogisticRegression(C=0.01, class_weight=None, dual=False, fit_intercept=True,
intercept_scaling=1, max_iter=100000, multi_class=‘ovr’, n_jobs=1,
penalty=‘12’, random_state=None, solver=‘liblinear’, tol=0.0001.
verbose=0, warm_start=False)

However, other embodiments may utilize other values for the hyperparameters. At operation 506, the model is tested by examining the precision, recall, and F1-score values. During experimentation, it was observed that the precision and recall values in the training set and the test set are similar, therefore, the model is not overfitting. If the test passes, the method proceeds to operation 508, and if the test does not pass, the user is notified at operation 512.

At operation 508, the logistic regression model to be used in production is trained. The model may be trained periodically to incorporate additional available information, such as new labeled data or new rules for labeling data. In operation 510, the model is tested. If the test passes, the model parameters 516 are saved for categorizing the employment status of members of the social network. If the test fails, the user is notified at operation 514.

In some example embodiments, before training the ML model, some checks are performed on the input feature data and the input data is compared to the previous version of input data to ensure that the data for the model has not changed substantially since the last training of the ML model.

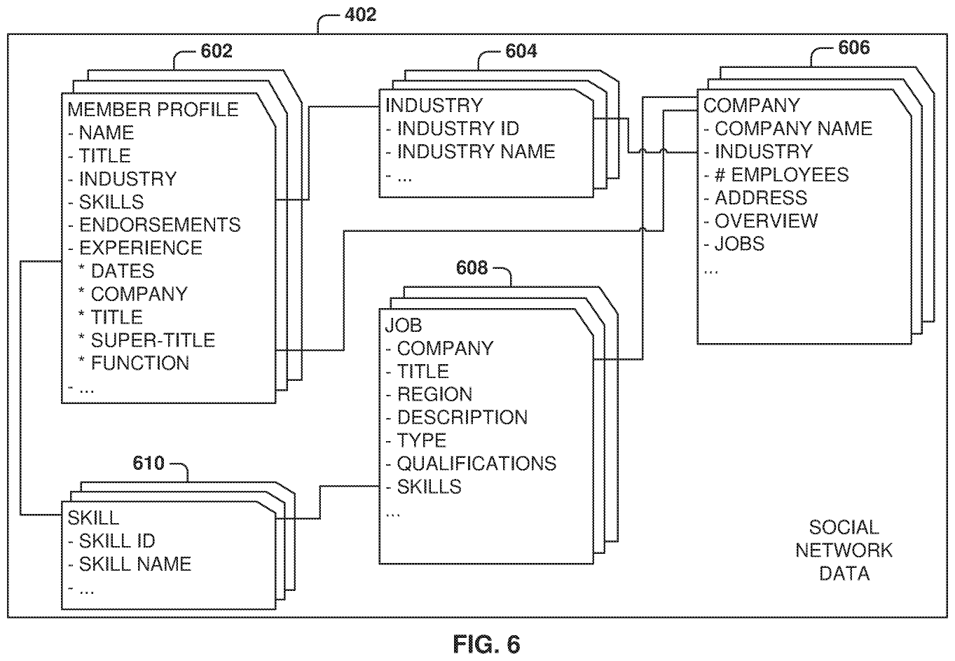

FIG. 6 illustrates data structures for storing the social network data 402, according to some example embodiments. Each user in the social network has a member profile 602, which includes information about the user. The member profile 602 is configurable by the user and includes information about the user and about user activity in the social network (e.g., likes, posts read).

In one example embodiment, the member profile 602 may include information in several categories, such as experience, education, skills and endorsements, accomplishments, contact information, following, and the like. Skills include professional competences that the member has, and the skills may be added by the member or by other members of the social network. Example skills include C++, Java, Object Programming, Data Mining, Machine Learning, Data Scientist, and the like. Other members of the social network may endorse one or more of the skills and, in some example embodiments, the account is associated with the number of endorsements received for each skill from other members.

The member profile 602 includes member information, such as name, title (e.g., job title), industry (e.g., legal services), geographic region, jobs, skills and endorsements, and so forth. In some example embodiments, the member profile 602 also includes job-related data, such as employment history, jobs previously applied to, or jobs already suggested to the member (and how many times the job has been suggested to the member). The experience information includes information related to the professional experience of the user, and may include, for each job, dates, company, title, super-title, functional area, industry, etc. Within member profile 602, the skill information is linked to skill data 610, the employer information is linked to company data 606, and the industry information is linked to industry data 604. Other links between tables may be possible.

The skill data 610 and endorsements includes information about professional skills that the user has identified as having been acquired by the user, and endorsements entered by other users of the social network supporting the skills of the user. Accomplishments include accomplishments entered by the user, and contact information includes contact information for the user, such as email and phone number.

The industry data 604 is a table for storing the industries identified in the social network. In one example embodiment, the industry data 604 includes an industry identifier (e.g., a numerical value or a text string), and an industry name, which is a text string associated with the industry (e.g., legal services).

In one example embodiment, the company data 606 includes company information, such as company name, industry associated with the company, number of employees, address, overview description of the company, job postings, and the like. In some example embodiments, the industry is linked to the industry data 604.

The skill data 610 is a table for storing the different skills identified in the social network. In one example embodiment, the skill data 610 includes a skill identifier (ID) (e.g., a numerical value or a text string) and a name for the skill. The skill identifier may be linked to the member profile 602 and job data 608.

In one example embodiment, job data 608 includes data for jobs posted by companies in the social network. The job data 608 includes one or more of a title associated with the job (e.g., software developer), a company that posted the job, a geographic region for the job, a description of the job, job type (e.g., full time, part time), qualifications required for the job, and one or more skills. The job data 608 may be linked to the company data 606 and the skill data 610.

In some embodiments, the social network imports jobs from other websites, such as the jobs page of the company, and those job postings may include an employment status (e.g., part-time, in-house). This information may also be used as features for the ML model.

Additionally, some members may enter salary data in their profiles, and the salary data may be entered as hourly or salaried. This signal may also be used as a feature for the ML model.

It is noted that the embodiments illustrated in FIG. 6 are examples and do not describe every possible embodiment. Other embodiments may utilize different data structures, fewer data structures, combine the information from two data structures into one, add additional or fewer links among the data structures, and the like. The embodiments illustrated in FIG. 6 should therefore not be interpreted to be exclusive or limiting, but rather illustrative.

FIG. 7 illustrates the feature-extraction process, according to some example embodiments. In some example embodiments, the social network data 402 is used to extract 702 features for determining employment type by company identifier and raw title.

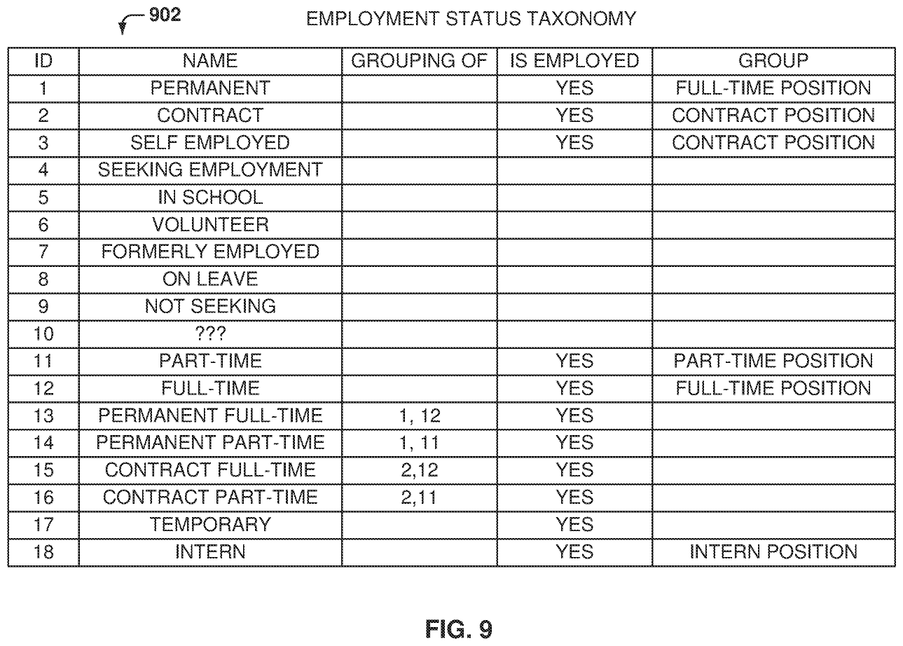

The extracted features 704 may be categorized under several categories, such as member-related features (e.g., related to the member profile 602), job-related features based on job data 608, and salary-related features. The extracted features 704, for each pair of title and company identifier, may include one or more of the following:
Tenure is less than six months 706, a Boolean value. The value is 1 if the median tenure of positions of employees with this raw title is less than six months in the company, and 0 otherwise. Interns and seasonal employees typically have a short tenure, so this feature will likely have a value of 1 for these seasonal employees. Another example embodiments, the threshold may be set at a period different from six months, such as a period between a month and a year.
Number of regions 707, which is the median number of regions where employees with this raw title are employed in this company. In some example embodiments, the regions are identified by ZIP Code, but other region identifiers may be used. Typically, field employees are more spread throughout the world, while companies have only a few corporate offices. The number of regions for a raw title is normalized by dividing the number of regions for the title by the maximum number of regions where a company has employees, in order to account for varying company size and geographical spread. Further, other techniques for normalizing regions, e.g., z-score normalization, may also be used.
Percentage of employees with more than one current position 708, Boolean value. Professionals like freelancers and contractors typically have multiple current positions and they tend to be field.
Employment status identifier 709 from employment taxonomy table (described below with reference to FIG. 9). The value is 1 if the employment status identifier is 1 or 13, and 0 for the other employment status identifiers.
Median number of connections in the social network with members who are current or past employees of the company 710. Since non-corporate employees do not work in the corporate office, these non-corporate employees tend to have a fewer number of connections than full-time-corporate employees of the company.
Percentage of employees that are open to contract, part time, or internship positions 711. Members of the social network sometimes indicate if they are willing to accept this type of jobs in their profile or their job search, so being open to contract, part time, or internship jobs provides another indication for classifying these employees as field.
Seniority 712, Boolean value. The seniority has a value of 1 if the title has a seniority modifier, and a value of 0 otherwise. Typically, field employees do not have seniority modifiers, while corporate employees include this modifier more often in their title.
Percentage of part time jobs for the title 703.
Percentage of jobs viewed that are part-time jobs 713. This is the percentage of jobs viewed, from all the jobs viewed, by employees with the same title, that are part-time jobs.
Percentage of jobs applied by members with the same title for jobs that are part-time 715.
Percentage of jobs for this title within the company where the salary data is specified as by the hour or by the day 716.
Features derived from the raw title 717. For example, the raw title is tokenized into words, stop words are removed, and get unigrams, bigrams, and trigrams are obtained and then hashed to generate features.

The features described above are calculated for a company and raw title, except percentage of part time jobs for title 703 and percentage of jobs where the salary data is specified as by the hour or by the day 716. These two features are calculated for company and standardized title and joined with other feature values using key (company, standardized title) to determine the final feature set. The reason is because some jobs and salary data points may be missed if with a join on raw title due to the wide variation in how members specify raw titles for a given standardized title.

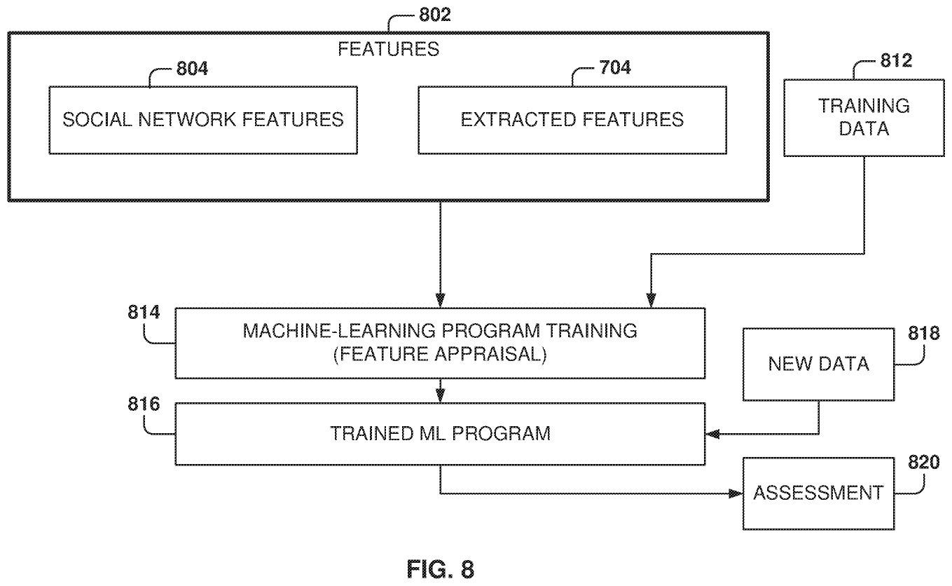

FIG. 8 illustrates the training and use of a machine-learning program, according to some example embodiments. In some example embodiments, machine-learning programs (MLP), also referred to as machine-learning algorithms or tools, are utilized to perform operations associated with searches, such as job searches.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 812 in order to make data-driven predictions or decisions expressed as outputs or assessments 820. Although example embodiments are presented with respect to a few machine-learning tools, the principles presented herein may be applied to other machine-learning tools.

In some example embodiments, different machine-learning tools may be used. For example, Logistic Regression (LR), Naive-Bayes. Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). The machine-learning algorithms utilize the training data 812 to find correlations among identified features 802 that affect the outcome.

The machine-learning algorithms utilize features for analyzing the data to generate assessments 820. A feature 802 is an individual measurable property of a phenomenon being observed. The concept of feature is related to that of an explanatory variable used in statistical techniques such as linear regression. Choosing informative, discriminating, and independent features is important for effective operation of the MLP in pattern recognition, classification, and regression. Features may be of different types, such as numeric, strings, and graphs.

In one example embodiment, the features 802 may be of different types and may include one or more of social network features 804 and extracted features 704. The social network features 804 include all or part of the social network data 402, as described above with reference to FIG. 6. The extracted features 704 include all or part of the features described above with reference to FIG. 7. The data sources include member standardized data, jobs standardized data, member connections, member employment preferences, job views, job applied, job information, salary information, etc.

The machine-learning algorithms utilize the training data 812 to find correlations among the identified features 802 that affect the outcome or assessment 820. In some example embodiments, the training data 812 includes known data for one or more identified features 802 and one or more outcomes, such as the employment type (field or full-time-corporate).

With the training data 812 and the identified features 802, the machine-learning tool is trained at operation 814. The machine-learning tool appraises the value of the features 802 as they correlate to the training data 812. The result of the training is the trained machine-learning program 816.

When the machine-learning program 816 is used to perform an assessment, new data 818 is provided as an input to the trained machine-learning program 816, and the machine-learning program 816 generates the assessment 820 as output. For example, data for a pair of title and company identifier is assessed to determine the employment type.

In some example embodiments, part of the data (e.g., 90%) is used to train the machine-learning program and the rest is reserved for testing and validation. In some example embodiments, the model output is evaluated sampling results and manually validating these results. The results may be evaluated by human judges, or may be evaluated by asking members of the social network directly to confirm the validity of the predictions, or by asking the employers to confirm the predictions for the given title or titles. By evaluating the sample results, it is possible to determine the accuracy of the predictions by the model.

FIG. 9 is a table 902 for an employment status taxonomy, according to some example embodiments. The employment taxonomy table defines several job types as related to the type of employment, possible groupings by the different job types, a flag indicating if the member is employed, and whether the job is full-time, part-time, contract, or for an intern. FIG. 9 illustrates an example embodiment of a group of employment status, but the employment status taxonomy may have additional or fewer entries.

The employment names include permanent, contract, self employed, etc. In additional some jobs may be combined, such as permanent full-time, which is a grouping of permanent and full time. The flag “Is Employed” indicates if the job indicates that the employee is currently employed. For example, “Seeking Employment” indicates that the member is not employed.

In some example embodiments, employments with IDs 1 and 13 are considered full-time-corporate, and the other employment IDs are considered field.

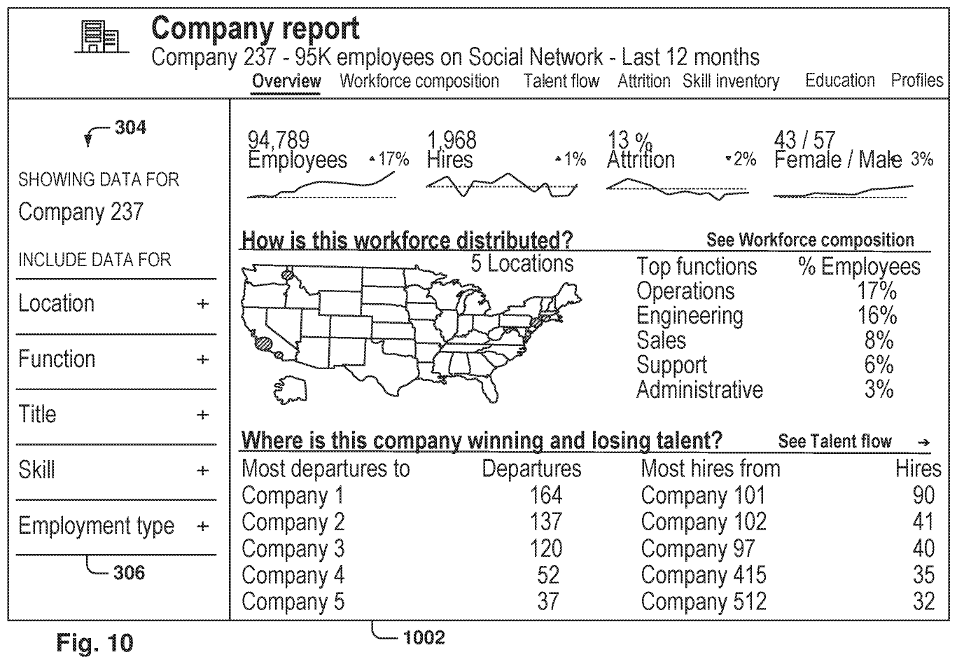

FIG. 10 is a workforce-distribution report for a company, according to some example embodiments. The company report for a particular company (e.g., Company 237 in this example) provides information about the labor composition of the company.

The company report 1002 shows that Company 237 has 94,789 employees with profiles in the social network over the last 12 months. The report 1002 further includes the number of employees, the number of hires, the attrition rate, and the ratio of female to male, with respective linear graphical representations of these values.

Additionally, the company report 1002 shows how the workforce is distributed for this company, illustrated by a map of the United States with circles proportional in size to the concentration of employees. A table next to the map also breaks down the percentage of employees by function, such as Operations, Engineering, Sales, Support, and Administrative.

Further below, a couple of tables indicate where the company is winning and losing talent. A first table on the left shows the companies where employees of Company 237 are going and the number of departures, and a second table on the right shows the companies from which Company 237 is hiring, together with the number of hires within the last 12 months. Company report 1002 provides a dashboard of information for the company as well as some information about competitors for talent.

The user interface includes the parameter-selection area 304 for setting filters associated with the talent report. In some example embodiments, the filters include location, function (e.g., marketing), title, skill, and employment type. The employment type option includes an option for selecting field or full-time-corporate, as well as other options related to employment, such as permanent employee, contractor, etc.

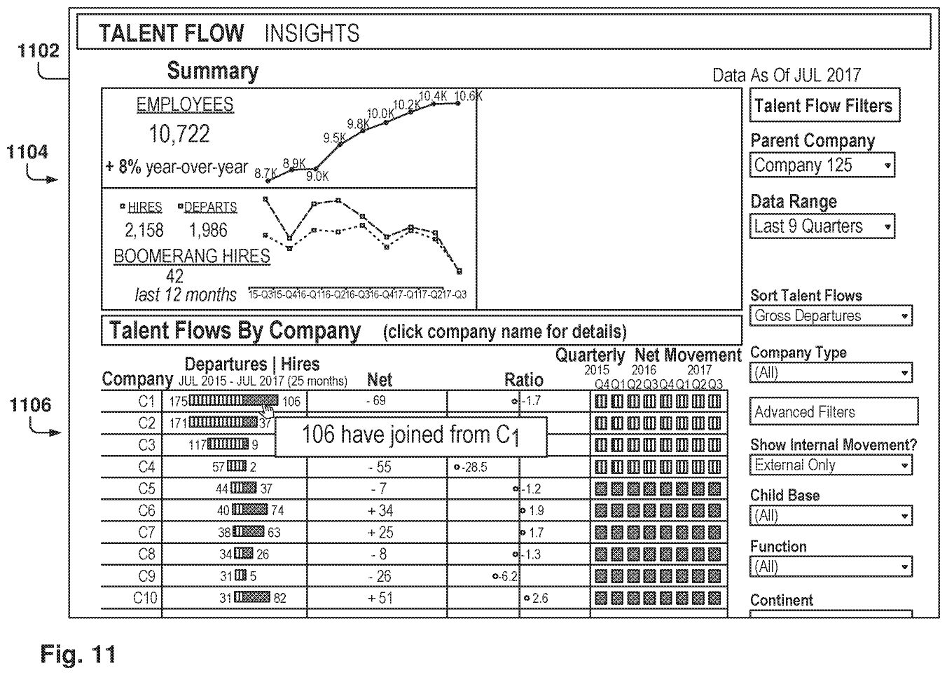

FIG. 11 is a report for talent flow between companies, according to some example embodiments. FIG. 11 provides a dashboard 1102 for talent flow insights. A top section 1104 includes a summary with charts for the number of employees over time, and the number of hires and departures over time. The charts show that the number of employees have steadily grown over time, but that in recent times the number of hires and departures are similar, indicating lack of employee growth at the company.

Further, a bottom section 1106 indicates how the talent flows by company. The table includes an entry for each company with hires or departures with respect to Company 237, and includes the double horizontal bar for departures and hires, as described above with reference to FIG. 17. As shown, if a mouse is placed over the bar, additional information is provided. Other columns indicate the net gain of employees, the ratio between hires and departures, and a color-coded representation of the inflow or outflow, by quarter.

For each quarter, a color-coded square shows an indication of the employee flow. For example, the squares for the first entry for company C₁, show a prevalent red color, which indicates that the company has been losing employees to company C₁. On the other hand, the squares for company C₁₀ are mainly green, indicating that the company has been gaining talent from C₁₀.

In some example embodiments, filters may also be used to select the employment type (field or full-time-corporate) for the talent flow report.

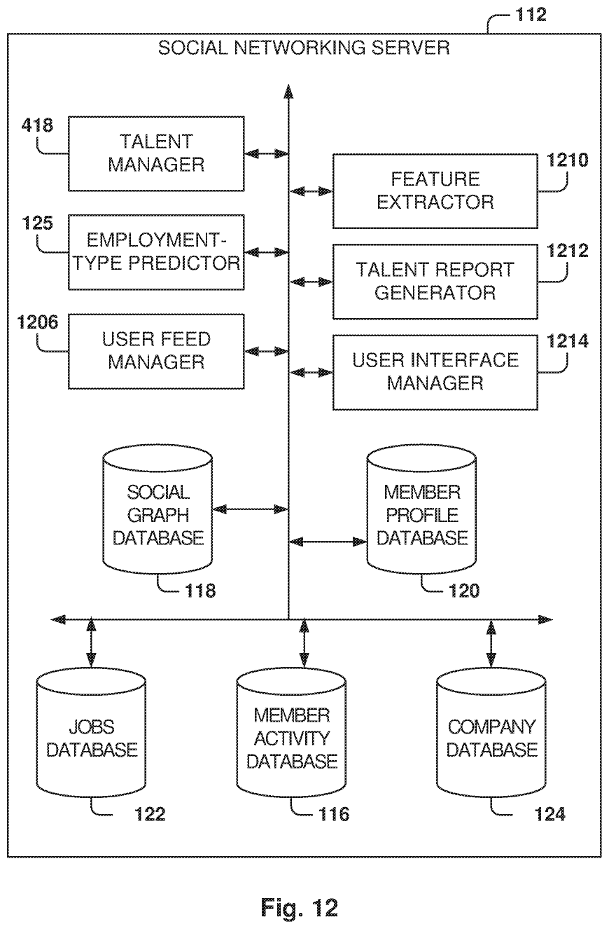

FIG. 12 illustrates a social networking server 112 for implementing example embodiments. In one example embodiment, the social networking server 112 includes a talent manager 418, an employment-type predictor 125, a feature extractor 1210, a talent report generator 1212, a user feed manager 1206, a user interface 1214 manager, and a plurality of databases, which include the social graph database 118, the member profile database 120, the jobs database 122, the member activity database 116, and the company database 124. In some example embodiments, the jobs database 122 is used to store analytical information regarding job post performance and other job-related data, such as number of daily views, job slots, job scores, jobs marked as rotatable, etc. Further, the member profile database 120 may be used to store the employment type of members.

The talent manager 418 coordinates activities for the generation of talent reports. In some example embodiments, the employment-type predictor 125 includes a machine-learning algorithm, for determining the employment type, which utilizes a plurality of features, as described above. The feature extractor 1210 extracts features from the social network data 402, as described above with reference to FIG. 7.

The talent report generator 1212 generates talent reports that are presented in the user interface provided by the user interface manager 1214. The user feed manager 1206 assists in tracking the interaction of users with jobs. The user interface 1214 communicates with the client devices 104 to exchange user interface data for presenting the user interface 1214 to the member.

It is to be noted that the embodiments illustrated in FIG. 12 are examples and do not describe every possible embodiment. Other embodiments may utilize different servers or additional servers, combine the functionality of two or more servers into a single server, utilize a distributed server pool, and so forth. The embodiments illustrated in FIG. 12 should therefore not be interpreted to be exclusive or limiting, but rather illustrative.

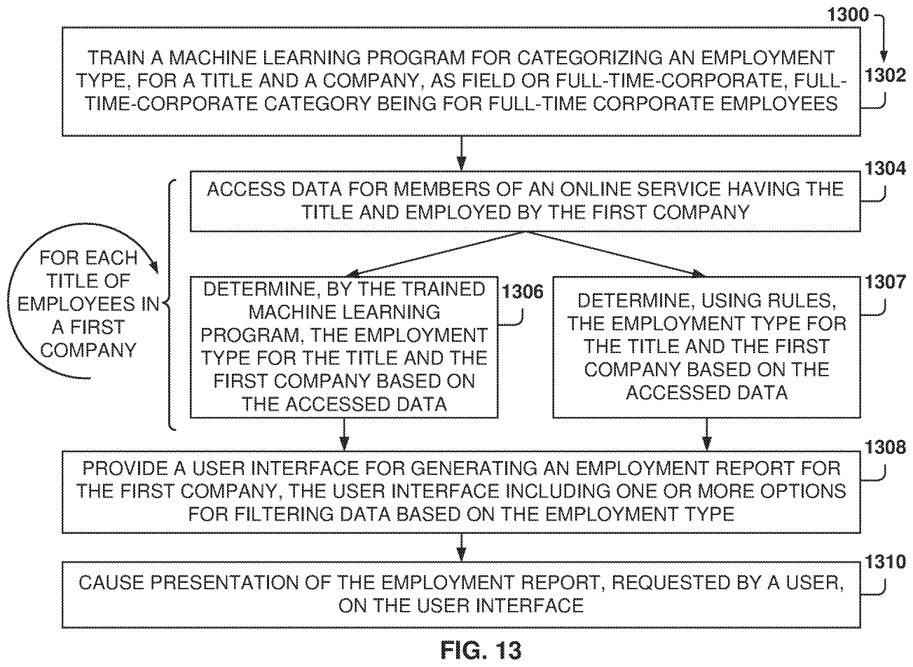

FIG. 13 is a flowchart of a method 1300 for determining employment type, according to some example embodiments. While the various operations in this flowchart are presented and described sequentially, one of ordinary skill will appreciate that some or all of the operations may be executed in a different order, be combined or omitted, or be executed in parallel.

At operation 1302, a machine learning program is trained for categorizing an employment type, for a title and a company, as field or full-time-corporate, full-time-corporate category being for full-time corporate employees.

For each title of employees in a first company, operations 1304 and 1306 or 1307 are performed. At operation 1304, data is accessed for members of an online service having the title and employed by the first company. If the determination of the employment type is performed by the machine learning program, the method flows to operation 1306, and if the determination of the employment type is performed by using rules, the method flows to operation 1307.

At operation 1306, the trained machine learning program determines the employment type for the title and the first company based on the accessed data. At operation 1307, a program utilizes available rules to determine the employment type for the title and the first company based on the accessed data.

Operation 1308 is for providing a user interface for generating an employment report for the first company, the user interface including one or more options for filtering data based on the employment type.

From operation 1308, the method flows to operation 1310 for causing presentation of the employment report, requested by a user, on the user interface.

In one example, training data, for training the machine learning program, includes social network data and extracted features based on the social network data.

In one example, the social network data includes one or more of member profile data, company data, and job data.

In one example, the extracted features include a tenure of an employee in the company, a number of regions for employees with the title, percentage of employees with more than one current position, and employment category.

In one example, the extracted features include a median number of connections with members who are current or past employees of the company, a percentage of employees that are open to contract, part time, or internship positions, seniority, and percentage of part time jobs for the title.

In one example, the extracted features include percentage of jobs viewed that are part-time jobs, percentage of jobs applied by members with the title for jobs that are part-time, percentage of jobs for the title where salary data is specified as by the hour or by the day, and features derived from the title.

In one example, the training data includes labeled data that is labeled by humans or labeled programmatically based on rules.

In one example, the method 1300 further includes periodically calculating the employment type for the titles of employees in the first company, storing the calculated employment type for the titles of employees in the first company, and utilizing the stored employment type for creating the employment report.

In one example, the employment report is a company report, wherein the employment report includes a number of employees in the first company, a number of job posts by the first company, a median compensation, and a geographical distribution of employees with a title selected for the employment report.

In one example, the options for filtering include employment type, location, function, title, and skill.

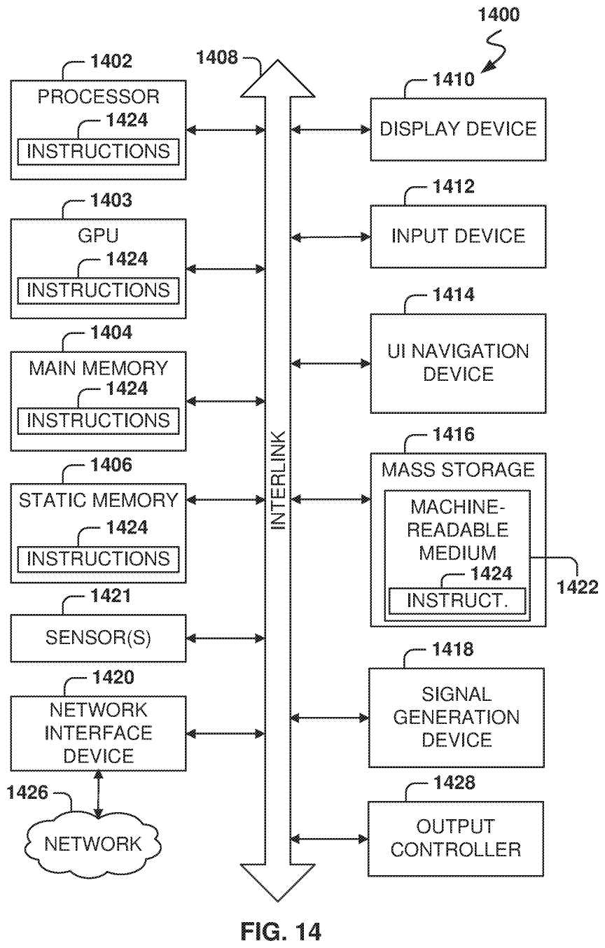

FIG. 14 is a block diagram illustrating an example of a machine 1400 upon or by which one or more example process embodiments described herein may be implemented or controlled. In alternative embodiments, the machine 1400 may operate as a standalone device or may be connected (e.g., networked) to other machines. In a networked deployment, the machine 1400 may operate in the capacity of a server machine, a client machine, or both in server-client network environments. In an example, the machine 1400 may act as a peer machine in a peer-to-peer (P2P) (or other distributed) network environment. Further, while only a single machine 1400 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, by moveable placement of invariant massed particles, etc.) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 1400 may include a hardware processor 1402 (e.g., a central processing unit (CPU, an FPGA), a hardware processor core, or any combination thereof), a graphics processing unit (GPU) 1403, a main memory 1404 (e.g., RAM, NVRAM), and a static memory 1406, some or all of which may communicate with each other via an interlink (e.g., bus) 1408. The machine 1400 may further include a display device 1410, an alphanumeric input device 1412 (e.g., a keyboard), and a user interface (UI) navigation device 1414 (e.g., a mouse). In an example, the display device 1410, alphanumeric input device 1412, and UI navigation device 1414 may be a touch screen display. The machine 1400 may additionally include a mass storage device (e.g., drive unit, SSD drive) 1416, a signal generation device 1418 (e.g., a speaker), a network interface device 1420, and one or more sensors 1421, such as a Global Positioning System (GPS) sensor, compass, accelerometer, or another sensor. The machine 1400 may include an output controller 1428, such as a serial (e.g., universal serial bus (USB)), parallel, or other wired or wireless (e.g., infrared (IR), near field communication (NFC), etc.) connection to communicate with or control one or more peripheral devices (e.g., a printer, card reader, etc.).

The mass storage device 1416 may include a machine-readable medium 1422 on which is stored one or more sets of data structures or instructions 1424 (e.g., software) embodying or utilized by any one or more of the techniques or functions described herein. The instructions 1424 may also reside, completely or at least partially, within the main memory 1404, within the static memory 1406, within the hardware processor 1402, or within the GPU 1403 during execution thereof by the machine 1400. In an example, one or any combination of the hardware processor 1402, the GPU 1403, the main memory 1404, the static memory 1406, or the mass storage device 1416 may constitute machine-readable media.

While the machine-readable medium 1422 is illustrated as a single medium, the term “machine-readable medium” may include a single medium, or multiple media, (e.g., a centralized or distributed database, and/or associated caches and servers) configured to store the one or more instructions 1424.

The term “machine-readable medium” may include any medium that is capable of storing, encoding, or carrying instructions 1424 for execution by the machine 1400 and that cause the machine 1400 to perform any one or more of the techniques of the present disclosure, or that is capable of storing, encoding, or carrying data structures used by or associated with such instructions 1424. Non-limiting machine-readable medium examples may include solid-state memories, and optical and magnetic media. In an example, a massed machine-readable medium comprises a machine-readable medium 1422 with a plurality of particles having invariant (e.g., rest) mass. Accordingly, massed machine-readable media are not transitory propagating signals to the extent local law does not permit claiming signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks: and CD-ROM and DVD-ROM disks.

The instructions 1424 may further be transmitted or received over a communications network 1426 using a transmission medium via the network interface device 1420.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
training a machine learning program for categorizing an employment type, for a title and a company, as field or full-time-corporate, full-time-corporate category being for full-time corporate employees;
for each title of employees in a first company:
accessing data for members of an online service having the title and employed by the first company; and
determining, by the trained machine learning program, the employment type for the title and the first company based on the accessed data:
providing a user interface for generating an employment report for the first company, the user interface including one or more options for filtering data based on the employment type; and
causing presentation of the employment report, requested by a user, on the user interface.

2. The method as recited in claim 1, wherein training data, for training the machine learning program, includes social network data and extracted features based on the social network data.

3. The method as recited in claim 2, wherein the social network data includes one or more of member profile data, company data, and job data.

4. The method as recited in claim 2, wherein the extracted features include a tenure of an employee in the company, a number of regions for employees with the title, percentage of employees with more than one current position, and employment category.

5. The method as recited in claim 2, wherein the extracted features include a median number of connections with members who are current or past employees of the company, a percentage of employees that are open to contract, part time, or internship positions, seniority, and percentage of part time jobs for the title.

6. The method as recited in claim 2, wherein the extracted features include percentage of jobs viewed that are part-time jobs, percentage of jobs applied by members with the title for jobs that are part-time, percentage of jobs for the title where salary data is specified as by the hour or by the day, and features derived from the title.

7. The method as recited in claim 2, wherein the training data includes labeled data that is labeled by humans and data labeled programmatically based on rules.

8. The method as recited in claim 1, further comprising:
periodically calculating the employment type for the titles of employees in the first company,
storing the calculated employment type for the titles of employees in the first company; and
utilizing the stored employment type for creating the employment report.

9. The method as recited in claim 1, wherein the employment report is a company report, wherein the employment report includes a number of employees in the first company, a number of job posts by the first company, a median compensation, and a geographical distribution of employees with a title selected for the employment report.

10. The method as recited in claim 1, wherein the options for filtering include employment type, location, function, title, and skill.

11. A system comprising:
a memory comprising instructions; and
one or more computer processors, wherein the instructions, when executed by the one or more computer processors, cause the one or more computer processors to perform operations comprising:
training a machine learning program for categorizing an employment type, for a title and a company, as field or full-time-corporate, full-time-corporate category being for full-time corporate employees;
for each title of employees in a first company:
accessing data for members of an online service having the title and employed by the first company; and
determining, by the trained machine learning program, the employment type for the title and the first company based on the accessed data;
providing a user interface for generating an employment report for the first company, the user interface including one or more options for filtering data based on the employment type; and
causing presentation of the employment report, requested by a user, on the user interface.

12. The system as recited in claim 11, wherein training data, for training the machine learning program, includes social network data and extracted features based on the social network data, wherein the social network data includes one or more of member profile data, company data, and job data.

13. The system as recited in claim 12, wherein the extracted features include a tenure of an employee in the company, a number of regions for employees with the title, percentage of employees with more than one current position, and employment category.

14. The system as recited in claim 12, wherein the extracted features include a median number of connections with members who are current or past employees of the company, a percentage of employees that are open to contract, part time, or internship positions, seniority, and percentage of part time jobs for the title.

15. The system as recited in claim 11, wherein the instructions further cause the one or more computer processors to perform operations comprising:
periodically calculating the employment type for the titles of employees in the first company;
storing the calculated employment type for the titles of employees in the first company; and
utilizing the stored employment type for creating the employment report.

16. A non-transitory machine-readable storage medium including instructions that, when executed by a machine, cause the machine to perform operations comprising:
training a machine learning program for categorizing an employment type, for a title and a company, as field or full-time-corporate, full-time-corporate category being for full-time corporate employees;
for each title of employees in a first company:
accessing data for members of an online service having the title and employed by the first company; and
determining, by the trained machine learning program, the employment type for the title and the first company based on the accessed data:
providing a user interface for generating an employment report for the first company, the user interface including one or more options for filtering data based on the employment type; and
causing presentation of the employment report, requested by a user, on the user interface.

17. The non-transitory machine-readable storage medium as recited in claim 16, wherein training data, for training the machine learning program, includes social network data and extracted features based on the social network data, wherein the social network data includes one or more of member profile data, company data, and job data.

18. The non-transitory machine-readable storage medium as recited in claim 17, wherein the extracted features include a tenure of an employee in the company, a number of regions for employees with the title, percentage of employees with more than one current position, and employment category.

19. The non-transitory machine-readable storage medium as recited in claim 17, wherein the extracted features include a median number of connections with members who are current or past employees of the company, a percentage of employees that are open to contract, part time, or internship positions, seniority, and percentage of part time jobs for the title.

20. The non-transitory machine-readable storage medium as recited in claim 16, wherein the machine further performs operations comprising:
periodically calculating the employment type for the titles of employees in the first company;
storing the calculated employment type for the titles of employees in the first company; and
utilizing the stored employment type for creating the employment report.
